(19) United States
(12) Patent Application Publication
(10) Pub. No.: US 2004/0238107 A1
(43) Pub. Date: Dec. 2, 2004

(54) Prepreg forming method

(76) Inventor: Stephan G. Velleman, Anaheim, CA (US)

Correspondence Address: GENE SCOTT; PATENT LAW & VENTURE GROUP, 3140 RED HILL AVENUE, SUITE 150, COSTA MESA, CA, 92626-3440, US

(21) Appl. No.: 10/861,820

(22) Filed: Jun. 3, 2004

Related U.S. Application Data
(62) Division of application No. 10/446,892, filed on May 27, 2003.

(51) Int. Cl. B32B 31/00

(52) U.S. Cl. 156/181

(57) ABSTRACT

Fiber tow carrying a resin powder is dispensed from an unwind creel with the tow spread out using a comb. From here the tow is directed between a pair of bands and pressed onto the outer surface of a heated impregnation wheel. It is compressed against the wheel to melt the resin powder. The resin moves in a liquid state to be uniformly distributed across the tow strands. Pressure is applied by wheels pressing on the bands. The result is a composite tape that is cooled upon leaving the impregnation wheel and then wound onto a rewind drum or spool.

### RELATED APPLICATIONS

This application is a Divisional Application of a prior filed application having Ser. No. 10/446,892 and filing date of May 27, 2003 and entitled: Prepreg Forming Apparatus. Priority is claimed.

### INCORPORATION BY REFERENCE

Applicant(s) hereby incorporate herein by reference, any and all U. S. patents, U.S. patent applications, and other documents and printed matter cited or referred to in this application.

### BACKGROUND OF THE INVENTION

1. Field of the Invention

This invention relates generally to the preparation of reinforced plastic composite articles and more particularly to an apparatus and method for preparing matrix strips of polymeric fibers.

2. Description of Related Art

The following art defines the present state of this field: Goldsworthy, U.S. Pat. No. 4,440,593 describes reinforced plastic composite articles, which have a non-constant cross-sectional shape over their length, such that a first portion of the article has a different cross-sectional shape than a second portion of the article, and which portions may be integral with each other. In one embodiment, the article may have a non-constant cross-sectional shape with a constant cross-sectional volume over its length. In another embodiment, the article may have a non-constant cross-sectional shape and non-constant cross-sectional volume over its length. An apparatus and a method, which utilizes a die having a die channel of non-constant cross-sectional shape is employed. In the apparatus, a pair of first and second die-forming members are used, and form in one or both of the die-forming members a die channel having a first portion of a cross-sectional shape which is different than a cross-sectional of a second die channel portion over the length of the die channel. One of the die-forming members may move relative to the other or both may move together at a constant speed in order to effectively pultrude a reinforced plastic composite article.

Goldsworthy, U.S. Pat. No. 4,469,541 describes reinforced plastic composite articles, which have a non-constant cross-sectional shape over their length, such that a first portion of the article has a different cross-sectional shape than a second portion of the article, and which portions may be integral with each other. In one embodiment, the article may have a non-constant cross-sectional shape with a constant cross-sectional volume over its length. In another embodiment, the article may have a non-constant cross-sectional shape and non-constant cross-sectional volume over its length. An apparatus and a method, which utilizes a die having a die channel of non-constant cross-sectional shape is employed. In the apparatus, a pair of first and second die-forming members are used, and form in one or both of the die-forming members a die channel having a first portion of a cross-sectional shape which is different than a cross-sectional of a second die channel portion over the length of the die channel. One of the die-forming members may move relative to the other or both may move together at a constant speed in order to effectively pultrude a reinforced plastic composite article.

Goldsworthy, U.S. Pat. No. 4,498,941 describes a method for high speed continuous production of reinforced plastic sheets and reinforced plastic sheet laminate structures which may have widths ranging from relatively narrow to very wide. One or more layers of resin impregnated, fiber-containing, reinforced plastic composite material is brought into contact with surfaces of one or more endwise abutted relatively flat panels. The panel or panels are then passed between a pair of continuously rotating belts. A pressurized air body is formed in a plenum chamber which faces the interiorly presented surface of at least one of the belts and which air body is between the housing forming the plenum chamber and the interior surface of the belt. Preferably, a similar housing creates a pressurized air body between such similar housing and the other of the belts. In this way, the pressurized body of air forces the belts into intimate contact with the layers forming the reinforced plastic laminate structure. The body of air is generally at a uniform pressure in the area between the belts and associated housings. In like manner, a single sheet of resin impregnated fiber-containing material may be passed between the belts where the resin is cured during the application of pressure to form a rigid single ply sheet structure. The method may use an augmented cure so that a cure of the resin is initiated in a precuring mechanism, and the reaction proceeds to a final cure while the layer or layers pass between the belts. The belts may be heated so as to facilitate the curing of the resin matrix impregnated in the layer or layers containing the fiber-reinforcing material.

Lambing et al., U.S. Pat. No. 5,264,060 describes a method for making a fiber-reinforced resin sheet including providing an array of a plurality of resin film layers and fiber layers, passing the array through a die in order to consolidate the array. A pair of belts which are interposed respectively between the upper surface of the array and the die and the lower surface of the array and the die and move through the die, preferably without substantial relative movement between the array and the belts is provided in order to facilitate efficient manufacture while preserving desired end product surface characteristics. The process is preferably a pultrusion process with the belts moving under the influence of pulling force applied to the array. Pultrusion apparatus employing such belts in the manufacture of fiber-reinforced resin sheet is also disclosed.

Zanferrari, U.S. Pat. No. 5,298,097 describes an apparatus and method providing for thermally bonding a textile web while supporting the web continuously from the lay down point until the web is thermally bonded. The apparatus includes a heated transfer roll adjacent an endless moving belt. The transfer roll is located outside the belt loop on the opposite side of the belt from a guide roll. The belt passes around a first portion of the transfer roll with the web sandwiched between the belt and transfer roll. The heated transfer roll heats the web and the web is transferred to the transfer roll. The web is then directed through a nip formed by a calendar roll positioned adjacent a second portion of the transfer roll for thermally bonding the web.

Rohleder et al., U.S. Pat. No. 5,328,536 describes along a plane-sealing zone, a number of plastic film webs are sealed together under pressure and heat application. The plastic film webs run at equal or different distances from one another into the sealing zone and are guided over compression rolls. Between the compression rolls, which lie opposite each other in pairs, the plastic film webs are introduced and subjected to both pressure and heat. The plastic film webs are provided on one or both sides with sealing layers, which are incipiently melted by the action of heat, so that a sealing of the plastic film webs in layers one on top of the other occurs in the sealing zone.

Koba et al., U.S. Pat. No. 5,445,701 describes a method and apparatus for(manufacturing a sheet-prepreg reinforced with fibers wherein a sheet of fibers such as warp or woven fibers such as fabrics is conveyed between a pair of band belts one of which is coated with a film of thermoplastic resin which has been heated higher than its softening point to enhance resin-impregnating efficiency and prevent the impregnated resin from contacting air. Further, when the sheet of fibers or woven fibers is conveyed in this manner, the molten resin is not maintained on the manufacturing line, thereby preventing it from being deteriorated by heat. The apparatus can be thus kept under operation for a long time and the sheet-prepreg reinforced with the fibers can be made much higher in quality and the deterioration of the impregnated resin can be further delayed.

Kruger et al., U.S. Pat. No. 5,463,946 describes a continuous material press for the production of material sheets made of substances which require a high pressure and an intensive thickness reduction during the pressing process, with the press including a heated/cooled and driven central drum, and a circulating endless steel belt tensioned around the central drum, with the material to be pressed being guided and pressed between the shell surface of the central drum and the steel belt. An additional stationary pressing device comprised of elastic steel belt sections is located outwardly of the endless steel belt and is mounted in tension to variably increase the pressure on the endless steel belt and thus on the material. An opening is formed in the steel belt section mounted in which is a pipe for delivering compressed air or water vapor to interface on the endless steel belt and the stationary steel belt section, the compressed air or water vapor forming a lubricating film for reducing friction.

Kobayashi et al., U.S. Pat. No. 5,612,125 describes a prepreg obtained by stretching a material including, as a main component, an ultra-high-molecular-weight polyethylene having an intrinsic viscosity of 5-50 dl/g as measured at 135.degree. C. in decalin, to a total draw ratio of at least 20, subjecting the resulting stretched polyethylene material to a splitting treatment, and impregnating the resulting material with a thermosetting resin, and a process for producing said prepreg. The split stretched polyethylene material has improved adhesion to the impregnant resin and can be used as a good base material for prepreg.

Janis, U.S. Pat. No. 5,972,147 describes a process for producing a bonded nonwoven sheet from a lightly consolidated fibrous polyolefin sheet wherein the sheet is preheated on one or more preheating rolls, is bonded in one or more calendering nips, and is cooled on one or more cooling rolls. The process is used to make bonded polyolefin fibrous sheets that are smooth, are substantially impermeable to air and water, and are moisture vapor permeable.

Loubinoux et al., U.S. Pat. No. 6,294,036 describes a process for manufacturing composite sheets. The sheets are made of at least one ply of yarn with this ply having at least two materials with different melting points. The ply is introduced continuously into a zone where it is heated to a temperature between the two melting points and below the degradation temperature of the material having the lower melting point. This ply is then passed over at least one rotating bar heated to a temperature lying between the melting points and below the degradation temperature of the material with the lower melting point. The ply is then compressed on leaving the rotating bar and is cooled to form a composite web. The web is collected in the form of one or more composite plies.

Le et al., U.S. Pat. No. 6,381,883 describes a method and apparatus for continuously pressure decatising a fabric include a rotatable drum around which an endless belt is arranged to travel for conveying a fabric (and optionally a moisture laden textile) between the facing surfaces of the belt and the drum. The drum is heated and fabric is pressed between the belt and the drum as it is conveyed through the apparatus. The fabric is subjected to pressurized saturated steam, which may be generated by evaporation of the moisture in textile when it contacts the heated drum, as it is pressed. Various options other than use of a moisture-laden textile for supplying the steam are disclosed. The invention involves enclosing the drum in a pressure vessel within which a compressed air atmosphere at ambient temperature is maintained. The surrounding compressed air atmosphere can be used to control the steam temperature, that is, the saturated steam temperature can be changed by changing the pressure of the surrounding compressed air. The surrounding compressed air atmosphere also reduces the sealing requirements for the steam treatment and belt wear. The method and apparatus are also applicable for setting staple fibers.

Belvin et al., U.S. Pat. No. 2001/0001408 describes an apparatus for producing a consolidated, fiber-reinforced composite tape from a plurality of powder pre-impregnated fiber tow bundles having a fiber and a polymeric matrix comprise six major components. Starting at the supply end of the manufacturing line, the components include a pay-out creel, a collimation device, a processing component with an impregnation bar assembly, variable-dimension forming nip-rollers, a self-contained driving mechanism, and a motorized take-up spool. These six components are positioned inoperable relationship to one another. The method of producing the consolidated composite tape includes the steps of: feeding the plurality of the tow bundles through the collimation device to align the tow bundles laterally; heating the tow bundles to a specific processing temperature which melts the polymeric matrix of the tow bundles; spreading the heated tow bundles over the impregnation bar assembly to wet-out the filament array of the heated tow bundles and to form the heated tow bundles to an initial width and shape; re-shaping the heated tow bundles into a pre-determined width by pulling the heated tow bundles through the variable-dimension forming nip rollers; pulling the shaped tow bundles through the self-contained drive mechanism, thereby enabling the polymeric matrix of the shaped tow bundles to consolidate fully into the fiber-reinforced composite tape; and taking-up the consolidated fiber-reinforced composite tape onto the spool.

The prior art teaches reinforced plastic composite articles and apparatus and methods of making them including sheet structures, a method for pultruding fiber-reinforced thermoplastic stock, thermal bonding of textile webs, producing multilayered film composite from co-extruded plastic film webs, apparatus for producing prepreg, especially for manufacturing a sheet prepreg reinforced with fibers, a continuously operating material press with lubricating film for reducing friction, a method for making fibrous, bonded polyolefin sheet and composite sheet, continuous pressure decatising of fabrics and setting of staple fiber assemblies, and a method and apparatus to fabricate a fully-consolidated fiber-reinforced tape from polymer powder pre-impregnated fiber tow bundles for automated tow placement. However, the prior art does not teach a method for melt-flow and impregnation of fiber tow without using liquid solvents or a wet base to control fiber spreading, and control of the spread of resin impregnation to produce a precise prepreg tape without gaps or voids. The present invention fulfills these needs and provides further related advantages as described in the following summary.

### SUMMARY OF THE INVENTION

The present invention teaches certain benefits in construction and use which give rise to the objectives described below.

This invention covers an impregnation process in a machine designed to manufacture a fully consolidated fiber-reinforced composite tape from multiple powder-impregnated fiber tows. The fibers used can be carbon fiber, glass fiber or any of the aramid fibers. The polymeric matrix can be from low-flow thermo-plastic such as PEI (polyetherimide) to high-flow epoxy thermo-set polymers. Deposition of low-flow thermo-plastic polymers onto fiber tow bundles is achieved by powder coating. The powdered polymeric matrix, commonly referred to as resin, is in solid form at ambient temperature and is melted to a lower viscosity to facilitate resin flow and impregnation into the fiber bundle at a controlled elevated process temperature.

This invention centers around the process of a novel machine capable of melt-flow and impregnation into the fiber tow and all its filaments without the assistance of liquid solvents or a wet base of any kind. It controls the spreading of the fiber, the impregnation of the resin, the consolidation of all the fiber tow bundles into a precise prepreg tape without gaps or voids, without guiding or sliding the fibers over any bars, heaters or anti-friction devices as shown in the prior art and that tends to abrade the fibers. Such abrasion removes leads to a high percentage of wasted product.

The instant manufacturing process includes the following sequence of steps to produce a fully impregnated continuous fiber reinforced prepreg.

A number of powder coated fiber spools, as required by the specific prepreg to be produced, are mounted on a fiber unwind creel. The specific number of tows required are threaded through the eyelets that guide the fiber tows to the front of the creel. Fibers are then placed in the appropriate order through a comb section which controls the lateral spacing of the fibers tows. The comb section is installed as close as possible to the impregnation wheel of the machine to maintain fiber spacing into the combining nip point of two metal belts. Starting at the initial nip point, at which the two metal belts come together and until they separate again at the other end of the impregnation process, the powder coated fibers are held in place by compressive forces between the two metal belts. The collective layers, bottom metal belt, fibers and polymer, and top metal belt are guided through a metal belt guide that controls the metal belts mutual alignment in both the vertical as well as horizontal direction. After this centering device, the metal belts are guided onto a circular and flanged impregnation wheel. The impregnation wheel is equipped with heating capacity to meet the specific polymeric matrix melt rate requirements, prepreg tape width, and the requirements to achieve an economically feasible production rate. As these requirements change from one combination of circumstances to another, the size and configuration of the impregnation wheel can be changed to meet the specific requirements. The ability to adapt the impregnation wheel size and specifications to meet process requirements is one of the advantages of this invention. The impregnation wheel is heated at its outer surface to a preset temperature capable of melting the polymer and thus reduce its viscosity so as to allow it to flow and encapsulate the fiber bundle and its many fiber filaments. To shield the mechanical mounting bearings from the temperature generated at the rim of the impregnation wheel, a center water cooled shaft is used. This shaft is of a design that permits the mounting of a chain drive sprocket, a rotary fluid coupling to enter and exit the cooling medium and the mounting bearings for the entire assembly. The outer rim of the impregnation wheel is flanged on both sides to insure metal alignment of the belts as they travel around the wheel.

As the impregnation wheel rotates, driven by an electric motor drive, heat transfers from the outer impregnation wheel rim to the bottom metal belt, the fiber bundle and to the outer metal belt. This heat transfer is very rapid, as the metal belts and the fiber bundle do not have a significant thermal mass. The belts are held at high tension to insure against separation around the impregnation wheel and to insure even compression forces around the circumference of the impregnation wheel rim. Proper belt tension also insures proper tracking of the belts around the impregnation wheel and the return guide idlers.

Mounted around the circumference of the impregnation wheel are a number of compression rollers. These rollers are mounted in a force multiplication lever system to provide the ability to apply variable compaction force toward the center of the compaction wheel. The compaction force is provided through the application of an air cylinder mounted at the end of the force multiplication lever system. The variable force, monitored by an air pressure gauge, can be adjusted up or down through an air pressure regulator, all mounted in a control panel. A selector On/Off switch for each of the eight compaction rolls provides the ability to select all or none or any combination of the compression rolls that will be in contact with the impregnation wheel. The compression rolls provide the ability to compact and impregnate the resin into the fiber bundle at a controlled and gradually increasing pressure from roll to roll around the circumference of the impregnation wheel, or at a rapid rate with high pressure at every compaction roll. This ability to vary the compaction and impregnation pressure the process to handle a wide rage of materials.

The amount of powdered polymeric matrix applied to the fiber tow varies by up to plus or minus eight percent. This represents peaks and valleys in the polymer matrix content on the powder coated fiber bundle. As the heated fiber bundle and polymer matrix travel around the impregnation wheel, sandwiched between the two steel belts, they are subjected to pressure points at the compression roll locations. The ability to adjust the specific pressure at the pressure points under the allows the process to accumulate a resin excess at any given pressure point which is then utilized to add resin in the resin deficient areas. In the art of prepreg fabrication this is commonly called “building a dam at a nip point.” This resin dam not only levels out the resin content over the width of the band, but also controls critical process conditions. For instance, a resin dam causes fiber filaments to be drawn into a straight line. This is especially critical on fiber tows that are not fully encapsulated by the powder coating process which leaves many small fiber filaments protruding away from the fiber tow at random directions and angles. Further, a resin dam has several horizontal force components that cause the fiber tow to be spread perpendicular to the direction of movement. This aids in the removal of hairline cracks or hairline gaps between tow bundles. This can be observed when examining the finished tape against a high intensity light source. Also, by pulling the fiber bundle through a resin dam, a very even and smooth surface finish is created. This uniform surface is most desirable in applications where many layers of tape are assembled into a structure. Finally, a resin dam also filters out air void pockets that are undesirable for high structural strength. The present invention has been found to provide these advantages with high repeatability, reliability and uniformity.

A primary objective of the present invention is to provide a method that provides advantages not taught by the prior art.

Another objective is to provide such an invention capable of high quality and highly uniform tape fabrication.

A still further objective is to provide such an invention at relatively low cost of use and with low cost of finished goods.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is a perspective view of the preferred embodiment of the apparatus used in the invention; and

FIG. 2 is a schematic diagram thereof.

### DETAILED DESCRIPTION OF THE INVENTION

The above described drawing figures illustrate the invention in at least one of its preferred embodiments, which is further defined in detail in the following description.

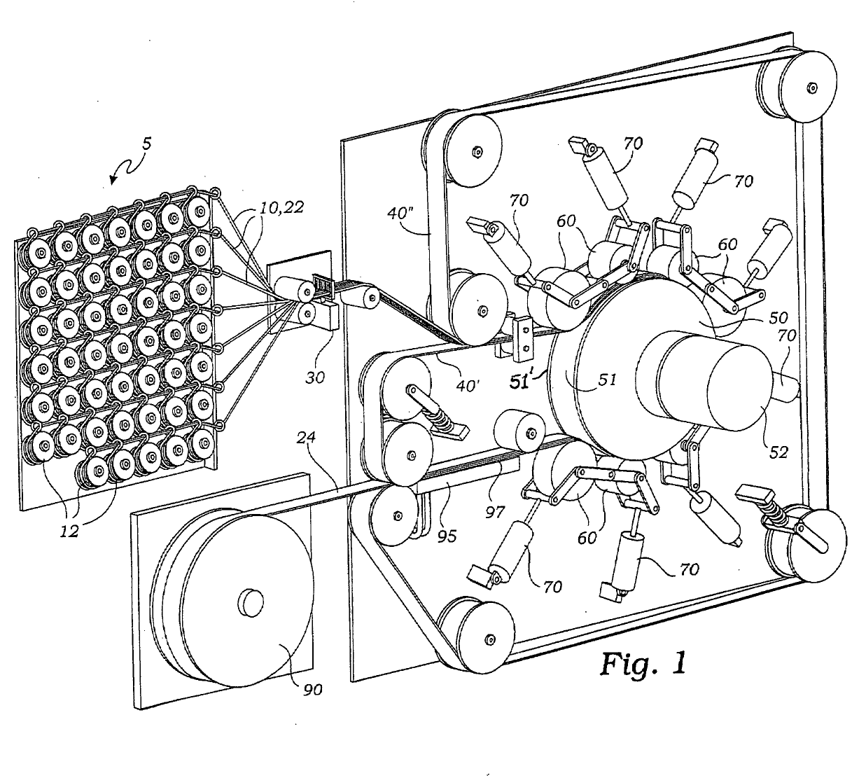

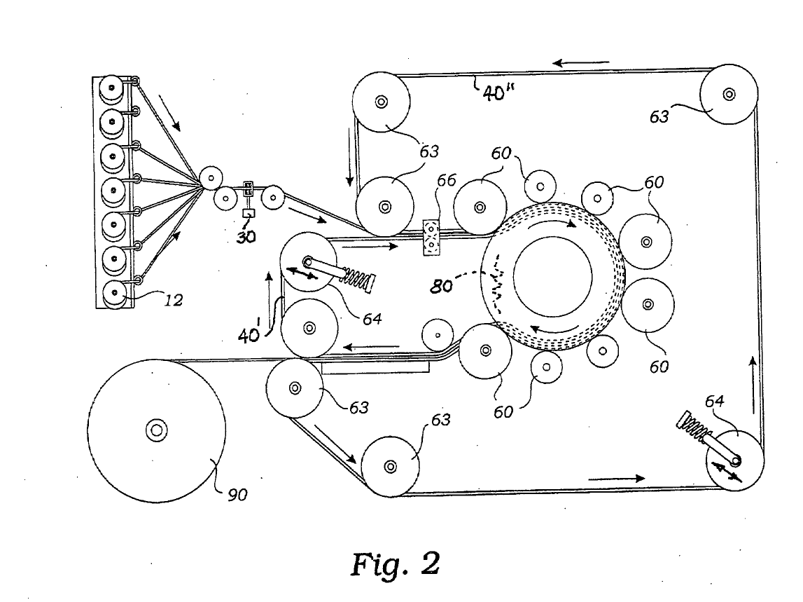

The present invention is a prepreg tape fabricating method. It is fabricated on a machine made up of several major components assembled in a novel manner to preform the task of making the prepreg tape in a superior fashion and it is necessary to understand the nature of the machine in order to fully understand the method. A means for dispensing, identified generally by numeral 5, dispenses fiber tows 10 that are covered with a resin powder 22 (a powdered polymeric matrix), and comprises a fiber unwind creel as is well known in this industry. Its function is to support a plurality of tow spools 12 holding a supply of filament tow material for use in the present process method. A means for collimating 30 such as a comb, well known in the art, receives the fiber tows 10 dispensed by the dispensing means 5 so that the fiber tows 10 are in lateral alignment and laid out in side by side orientation as they are pulled from the tow spools 12. An impregnation wheel 50 is driven in rotation by motor 52 and is principally encircled preferably by a pair of metal strip flexible belts 40′, 40″ which are wound around the wheel 50 with the laterally aligned fiber tows 10 sandwiched between them. From FIG. 1 it can be seen that the wheel 50 has an outer surface 51 which receives the belts 40′, 40″ and a pair of outwardly extending opposing flanges 51′ that function to keep the belts on the surface 50. The flexible belts 40′, 40″ comprise an inner one 40′ of the flexible belts, and this belt is in contact with the annular surface 51 of the impregnation wheel 50; and an outer one 40″ of the flexible belts, which is in contact, with the inner one 40′ of the flexible belts. In this description, the references “inner” and “outer” refer to the relative positions of the belts 40′, 40″ as they lie on the wheel surface 51. At least one of a plurality of pressure rollers 60, and preferably several, as shown in FIG. 1, are in face to face contact with the outer one 40″ of the pair of flexible belts. A means for pressing 70, such as a linear actuator, as for instance a pneumatic or hydraulic cylinder, forces the pressure rollers 60 against the outer one 40″ of the flexible belts enabling compression of the aligned fiber tows 10. A means for heating 80 of the annular surface 51 of the impregnation wheel 50, such as one or more of an electrical heating element which is shown schematically in FIG. 2, enables the melting of the resin powder 22 on the fiber tows 20 to form a composite integral flat tape 24 which is the product of the present apparatus and method of use. A means for cooling 95 of the fiber composite tape 24 is used to cool the tape 24 sufficiently for it to be rewound on a winding means 90. This cooling means 95 is preferably a heat sinked contact plate having a contact surface 97 over which the composite tape 24 slides; still, at this point, sandwiched between the flexible bands 40′, 40″, as shown. Extraction of heat from the bands and the tape 24 is accomplished, preferably, by water cooling the contact plate cooling means 95. Preferably, the pressure rollers 60 are set up as pairs of pressure rollers wherein each one of the pairs of pressure rollers 60 are placed in mutual compression, i.e. compressive forces are applied to the roller pairs. The roller pairs 60 are set apart by a distance appropriate for controlling the melting and impregnation of the fiber tows 10 as will be described presently. As seen in FIG. 2 schematically, idler wheels 63 are used to conduct the belts 40′, 40″ in their continuous circuit. Both of the belts move clockwise, in FIG. 2 with the rotation of the impregnation wheel 50, but belt 40″ move counter-clockwise external to wheel 50, while belt 40′ moves clockwise. Idler wheels 64 are engaged with springs to assure that the belts are maintained tight as they move in their circuits.

In the present prepreg tape preparation method the plurality of powder coated fiber tows 10 having a resin powder thereon are dispensed from a creel. Collimating the fiber tows 10 so that the fiber tows are in lateral alignment set the tows 10 in position for being impregnated. The aligned fiber tows 10 are next sandwiched between a pair of closed circuit flexible belts 40′, 40″ causing the winding of the aligned fiber tows 10 and the closed circuit flexible belts 40′, 40″ about the impregnation wheel 50 with the inner one of the flexible belts 40′ in contact with the annular surface 51 of the impregnation wheel 50. Next, the pressure rollers 60 apply pressure against the outer one of the pair of flexible belts 40″ thereby compressing the fiber tows between the belts 40′, 40″. Heating the annular surface 51 of the impregnation wheel 50 melts the resin powder 22 on the fiber tows 10 forming a composite tape 24, which is cooled as it exits the impregnation wheel 50. At least one pair of the pressure rollers 60 are placed in mutual compression as is best seen in FIG. 1. Pressure of rollers 60 is adjusted at pressure points against the belts 40′, 40″ to accumulate liquid resin excess at each pressure point. Resin deficient areas of the tow 10 are supplemented by this excess resin to provide uniform impregnation laterally.

While the invention has been described with reference to at least one preferred embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A prepreg tape preparing method comprising the steps of: dispensing a plurality of fiber tows having a resin powder thereon; collimating the fiber tows so that the fiber tows are in lateral alignment; sandwiching the aligned fiber tows between a pair of closed circuit flexible belts; winding the aligned fiber tows and the closed circuit flexible belts about a rotating impregnation wheel with an inner one of the flexible belts in contact with an annular surface of the impregnation wheel; pressing at least one of a plurality of pressure rollers against the outer one of the pair of flexible belts thereby compressing the fiber tows between the flexible belts; heating an annular surface of the impregnation wheel thereby melting the resin powder on the fiber tows forming a composite tape; and cooling the fiber composite tape.

2. The method of claim 1 further comprising the step of placing at least one pair of the pressure rollers in mutual compression.

3. The method of claim 1 further comprising the step of dispensing the fiber tows from a fiber unwind creel.

4. The method of claim 1 wherein the step of aligning of the fiber tows is completed by combing.

5. The method of claim 1 further comprising the step of winding up the composite tape after the composite tape is cooled.
